(19) United States
(12) Patent Application Publication
(10) Pub. No.: US 2014/0125178 A1
(43) Pub. Date: May 8, 2014

(54) MAGNETIC ELECTRICAL GENERATOR

(71) Applicant: Kenneth David Chase, Huntington, IN (US)

(72) Inventor: Kenneth David Chase, Huntington, IN (US)

(21) Appl. No.: 13/668,415

(22) Filed: Nov. 5, 2012

(51) Int. Cl. H02K 7/02

(52) U.S. Cl. 310/153

(57) ABSTRACT

A magnetic electrical generator includes a rotational device that rotates a flywheel. The flywheel includes a plurality of magnetic elements that are arranged to alternate in polarity. The plurality of magnets is rotated in between a top and a bottom of at least one pole piece, which creates an alternating B field that is coupled to a pickup coil.

### BACKGROUND OF THE INVENTION

The present invention relates to an electrical generator and, more particularly, to a magnetic electrical generator.

Currently, generators do not operate at a high frequency level. In a conventional generator, the rise and fall times are slow. Therefore, the conventional generators must be larger and have low energy to weight ratios. It is desired to have smaller and lighter generators for basic maneuverability and for generators located on aircraft devices. However, because of hysteresis, conventional generators cannot compensate for those needs.

As can be seen, there is a need for a generator that can operate at a high frequency level with a small size and low weight.

### SUMMARY OF THE INVENTION

In one aspect of the present invention, an electrical generator comprises a rotational device; a flywheel attached to said rotational device, wherein said flywheel is rotated by said rotational device; a plurality of magnetic elements attached to said flywheel, wherein said plurality of magnetic elements are arranged to alternate in polarity; at least one pole piece with a top end and a bottom end; and at least one pickup coil attached to said pole piece; wherein said plurality of magnetic elements is rotated in between said top end and said bottom end of said at least one pole piece.

These and other features, aspects and advantages of the present invention will become better understood with reference to the following drawings, description and claims.

### BRIEF DESCRIPTION OF THE DRAWINGS

FIG. 1 is a low perspective view of the invention;

FIG. 2 is a high perspective view of the invention;

FIG. 3 is a side view of the invention;

FIG. 4 is a perspective view of the invention omitting multiple elements for illustrative clarity;

FIG. 5 is a top view of the invention omitting multiple elements for illustrative clarity;

FIG. 6 is a section view of the invention along line 6-6 in FIG. 2;

FIG. 7 is a detail section view of the invention;

FIG. 8 is a detail section view of the invention;

FIG. 9 is a detail section view of the invention;

FIG. 10 is a detail section view of the invention;

FIG. 11 is a detail section view of the invention;

FIG. 12 is a section detail view of the invention along line 12-12 in FIG. 5; and

FIG. 13 is a graph of typical voltage wave form across pickup coil.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical generator. The electrical generator includes a rotational device that rotates a flywheel. The flywheel includes a plurality of magnetic elements that are arranged to alternate in polarity. The plurality of magnetic elements is rotated in between a top and a bottom of at least one pole piece, which creates an alternating B field that is coupled to a pickup coil.

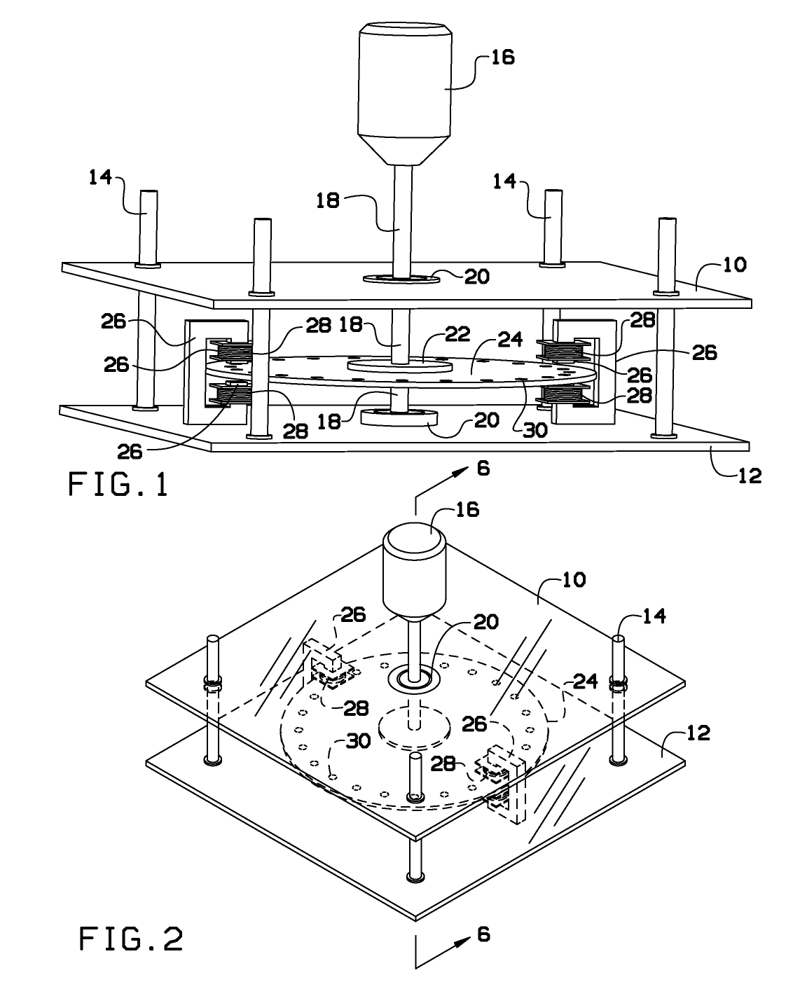

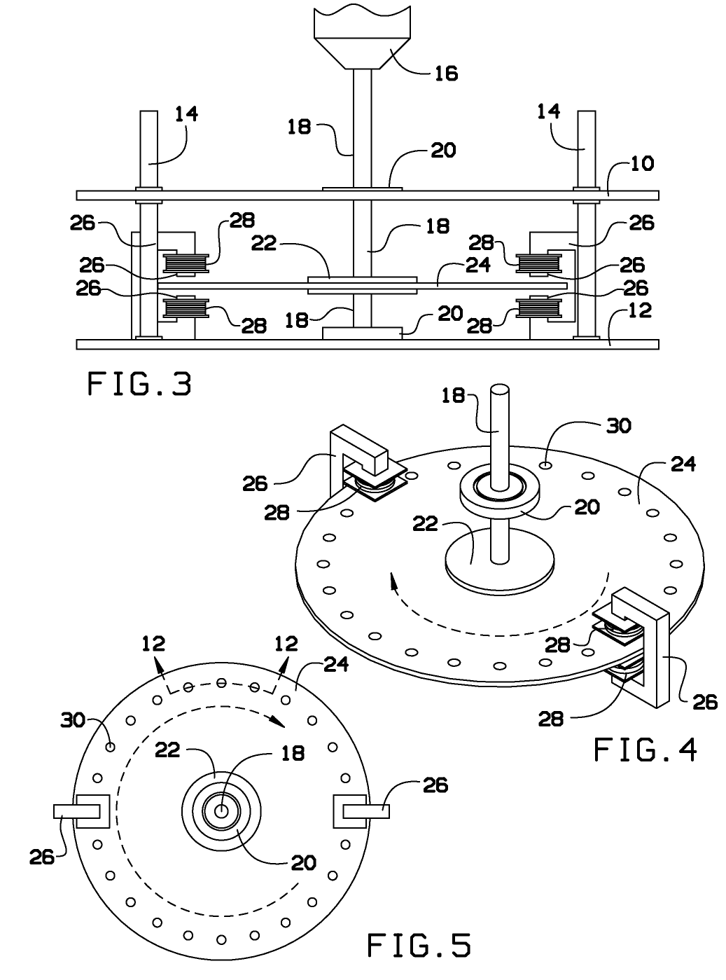

Referring now to FIGS. 1 through 6, the electrical generator may include a rotation device 16. In certain embodiments, the rotation device 16 may be an external mechanical rotation device. The rotation device 16 may further comprise a shaft 18. The shaft 18 may connect to and rotate a flywheel 24. In certain embodiments, the flywheel 24 may be connected to the shaft 18 via a flywheel hub 22.

As mentioned above, the flywheel 24 may be rotated by the shaft 18. In certain embodiments, the flywheel 24 has a round plate shape. However, the flywheel 24 may be any shape as long as the shape facilitates the generation of an alternating current (AC). In certain embodiments, the flywheel 24 includes a plurality of magnetic elements 30. The magnetic element 30 may be a permanent magnet, an electromagnet or a combination thereof. The plurality of magnetic elements 30 may be arranged on the flywheel 24 to alternate in polarity.

In certain embodiments, the electrical generator may include at least one pole piece 26. The pole piece 26 may include a top end and bottom end. The pole piece 26 may be a structure composed of material of high magnetic permeability that serves to direct the magnetic field produced by the plurality of magnetic elements 30. At least one pickup coil 28 may be attached to the pole piece 26. The pickup coil 28 may be wound wire. The start and the finish of the wound wire may be attached. In certain embodiments, the plurality of magnetic elements 30 on the flywheel 24 may be rotated between the top end and the bottom end of the pole piece 26. In such embodiments, a flux field is induced into the pole piece 26. The flux links to the pickup coil 28 creating an AC voltage across the pickup coil 28. When a load is connected across the pickup coil 28, electrical energy is produced.

In certain embodiments, there may be multiple pole piece assemblies. Any number of pole piece assemblies may be used. For example, as illustrated in FIGS. 1 through 6, the electrical generator may include two pole pieces 26 on opposite sides of the flywheel 24. The two pole pieces 26 may further comprise a pickup coil 28 attached to the top end and the bottom end of the pole pieces 26. In such embodiments, the plurality of magnetic elements 30 rotates in between the top end and the bottom end of both pole pieces 26.

The electrical generator may also include a housing. The housing is illustrated in FIGS. 1 through 6. The housing may include an upper plate 10 and a lower plate 12. The upper plate 10 may be attached to the lower plate 12 by a support 14. In certain embodiments, the rotation device 16 is an external rotation device located above the upper plate 10. The shaft 18 may be attached to the upper plate 10 and lower plate 12 by a bearing 20. The flywheel 24, the at least one pole piece 26 and the at least one pickup coil 28 may be supported in between the upper plate 10 and the lower plate 12. The shaft 18 may be attached to the flywheel 24 by a flywheel hub 22.

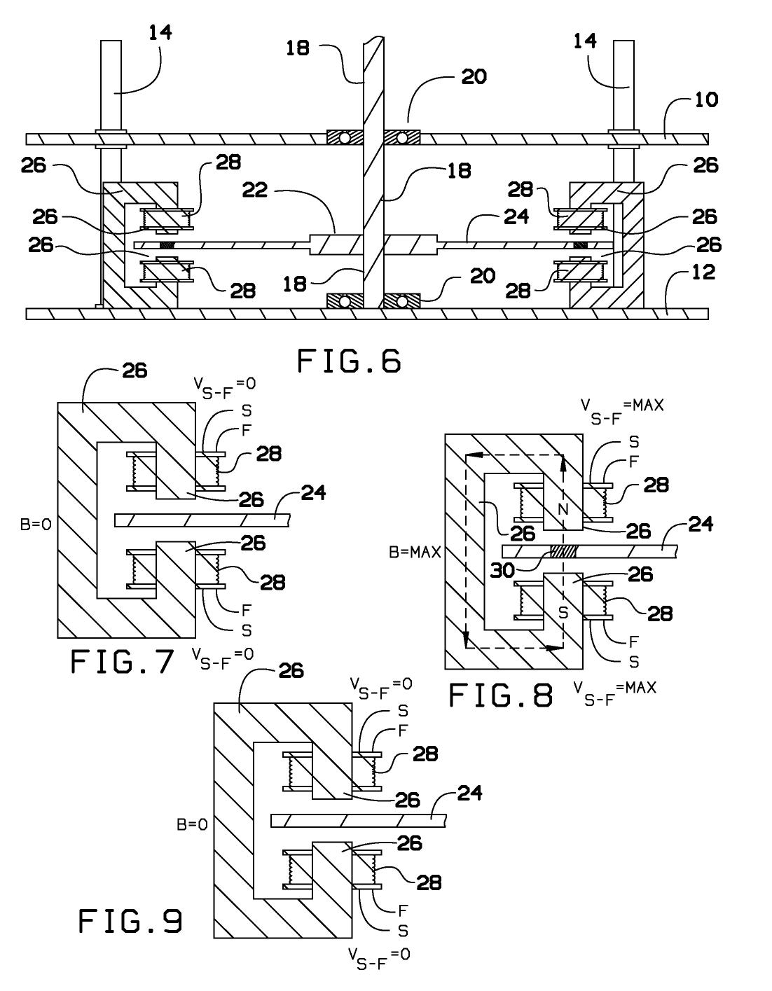

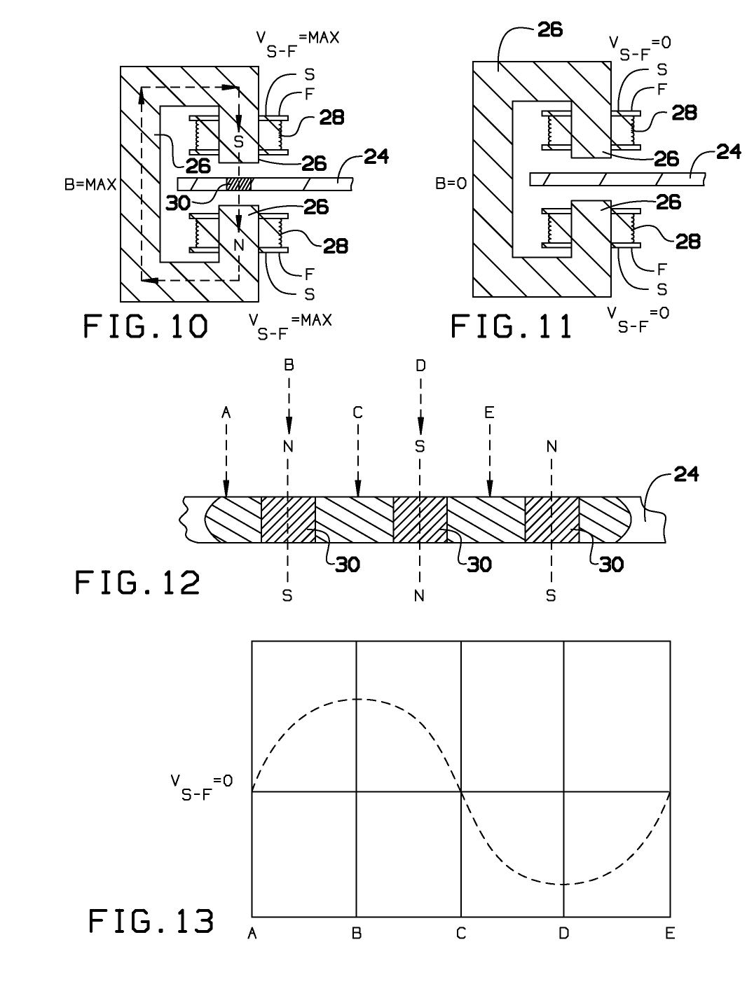

FIGS. 6 through 12 demonstrate the alternating magnetic polarity and the effect of magnetic elements 30 passing through the top end and bottom end of the pole piece 26. In the Figures, V is equal to voltage, B is equal to flux, and S and F represent the start and the finish of the wire included in the pickup coil 28. FIG. 12 illustrates the plurality of magnetic elements 30. As can be seen the plurality of magnets 30 are arranged to alternate in polarity. FIGS. 9 and 11 illustrate the flywheel 24 without the plurality of magnetic elements 30 in between the top end and the bottom end of the pole piece 26. In such embodiments, the voltage is equal to zero and the flux is equal to zero. FIGS. 8 and 10 illustrate the plurality of magnetic elements 30 in between the top end and the bottom end of pole piece 26. In such embodiments, the voltage output of the generator is maximized and the flux output of the generator is maximized. FIGS. 8 and 10 further provide illustrations of the alternate orientation of the magnetic polarity.

A method of making an electrical generator may include the steps of: installing a plurality of magnetic elements into a flywheel to create a magnetic array; configuring the flywheel to spin the magnetic array in between a top end and a bottom end of a pole piece; winding pickup coils; attaching the pickup coils near the bottom end and/or top end; and connecting the load to the pickup coil at the start and finish leads.

FIG. 13 demonstrates a typical voltage wave from across the pickup coil while in use. By mechanically inducing a flux in a magnetic medium, the voltage rise and fall time becomes extremely fast. By using mechanically induced flux, hysteresis is reduced allowing for high frequency operation. A high frequency operation results in size and weight reduction of a generator. In cases where electrical energy is needed but size and weight are critical, the present invention may be used. For example, an Aircraft or Aerospace application may benefit from the size and weight reduction of the electrical generator presented above.

The energy available from a magnetic element array in the case of a permanent magnet or a constant current electro magnet configuration may be the result of the strength of the H field of the magnets, (a constant) and the velocity, (a variable) that the flywheel propels the magnetic array through the gap in the pole piece assembly. The moving magnetic array may introduce an AC flux to the pole piece that in turn results in an AC voltage across the pickup coil per the expression Volts=dθdt. If the velocity of the flywheel is zero the volt second product, (ET) is zero, as the flywheel velocity is increased the ET product across the pickup coil increases until the threshold velocity of maximum ET product is reached. As the velocity of the flywheel increases above threshold velocity the ET product contribution of the discrete magnetic element may remain constant. However the energy provided by each magnetic element may double as the flywheel velocity doubles, and in addition the frequency of magnetic elements introduced to the pole piece assembly may double. Due to the play in both the time domain and frequency domain power available to a load across the pickup coil may increase four fold for each two fold increase in flywheel velocity. Therefore the energy available to a given load across the start and finish of the pick-up coil expressed in Watts is P=c^{V}^{²} where P=Watts, c=ET product, (constant), and V=velocity, (variable) of the magnetic array moving through the gap in the pole piece assembly.

It should be understood, of course, that the foregoing relates to exemplary embodiments of the invention and that modifications may be made without departing from the spirit and scope of the invention as set forth in the following claims.

What is claimed is:

1. An electrical generator comprising:
a rotational device;
a flywheel attached to said rotational device, wherein said flywheel is rotated by said rotational device;
a plurality of magnetic elements attached to said flywheel, wherein said plurality of magnetic elements are arranged to alternate in polarity;
at least one pole piece with a top end and a bottom end; and
at least one pickup coil attached to said pole piece,
wherein said plurality of magnetic elements is rotated in between said top end and said bottom end of said at least one pole piece.

2. The electrical generator of claim 1, further comprising a housing.

3. The electrical generator of claim 2, wherein said housing comprises an upper plate and a lower plate connected by a support.

4. The electrical generator of claim 1, wherein said rotational device further comprises a shaft.

5. The electrical generator of claim 4, wherein said shaft is connected to said flywheel, and said shaft rotates said flywheel.

6. The electrical generator of claim 1, wherein said at least one pickup coil is a pickup coil attached to at least one of said top end and said bottom end of said at least one pole piece.

7. The electrical generator of claim 1, wherein said at least one pole piece comprises two pole pieces.

8. The electrical generator of claim 7, wherein said two pole pieces comprise said pickup coil attached to said top end and said bottom end.

9. The electrical generator of claim 1, wherein when said plurality of magnetic elements is between said top end and said bottom end of said at least one pole piece, the voltage output of said generator is maximized.

10. The electrical generator of claim 1, wherein when said plurality of magnets is between said top end and said bottom end of said at least one pole piece, the flux output of said generator is maximized.
